(19) United States
(12) Patent Application Publication
(10) Pub. No.: US 2018/0191512 A1
(43) Pub. Date: Jul. 5, 2018

(54) PHYSICALLY UNCLONABLE FUNCTION GENERATION WITH DIRECT TWIN CELL ACTIVATION

(71) Applicant: INTEL CORPORATION, Santa Clara, CA (US)

(72) Inventor: Shigeki TOMISHIMA, Portland, OR (US)

(21) Appl. No.: 15/395,710

(22) Filed: Dec. 30, 2016

(51) Int. Cl. H04L 9/32; G06F 21/72

(52) U.S. Cl. CPC H04L 9/3278; H04L 2209/12; G06F 21/72

(57) ABSTRACT

In one embodiment, a physically unclonable function is generated with direct twin cell activation in the absence of execution of a prior write command or refresh operation for the bitcell. For example, a structural bit state activation logic directly activates complementary structural bit states of a pair of twin cells of a bitcell in response to an activation command, without any intervening write bit states generated in the bitcell by write commands or refresh operations preceding the activated structural bit states. Other aspects are described herein.

### TECHNICAL FIELD

Certain embodiments of the present invention relate generally to physically unclonable function devices using a memory.

### BACKGROUND

A physically unclonable function (PUF) may be used in cryptography to generate a cryptographic key which determines the functional output of a cryptographic algorithm. For example, one type of cryptographic algorithm is an encryption algorithm in which a key may be used to specify the transformation of text into encrypted text. Similarly, in a decryption algorithm, a key may be used to specify the transformation of encrypted text back into unencrypted text. Other types of cryptographic algorithms utilizing keys include digital signature schemes and message authentication codes to ensure authenticity.

To effectively maintain privacy or reliable authentication, a cryptographic key is preferably generated in a manner which is both random and has sufficient entropy which is a measure of uncertainty and is often related to the length of the key. In general, the greater the degree of randomness and entropy with which a cryptographic key is generated, the less likely that an unauthorized entity can guess the cryptographic key and obtain unauthorized access. Because cryptographic algorithms are frequently known or may be determined by analysis, it is often important to keep the cryptographic key as private. In general, the greater the degree of randomness and entropy in generating the key, the less likely the key can be guessed by an unauthorized entity.

A physically unclonable function may be provided by an integrated circuit device in which challenge-response pairs generate keys. For example, a challenge applied to the PUF device may provide a key in the form of a response to the challenge. The mapping between each challenge and its associated response of a challenge-response pair is typically determined by physical differences resulting from unpredictable variations encountered in the manufacture of the device. These unpredictable manufacturing process variations can provide a degree of randomness to the mappings and hence the key generation. Moreover, these physical differences and the associated mappings are often altered by unauthorized attempts to disassemble or otherwise reverse engineer the PUF device. Hence, the keys generated by PUF devices may be random, unique per device, unclonable and tamper resistant.

A number of different types of integrated circuits have been proposed for use as PUF devices. These prior proposals include use of logic circuitry including Arbiter PUF devices, Butterfly PUF devices, Ring Oscillator PUF devices, and coating PUF devices and use of memory element PUF devices including SRAM (Static Random Access) PUF devices, STT (Spin Transfer Torque) MRAM (Magnetic Random Access Memory) PUF devices, Re (Resistive) RAM PUF devices, Memorister PUF devices and DRAM (Dynamic Random Access Memory) PUF devices. However, the circuitry of these prior proposals has frequently exhibited one or more drawbacks such as being relatively complex, unreliable, large in size or a combination thereof.

A dynamic random access memory (DRAM) has a bitcell for storing charge to represent a bit as either a logical one or a logical zero. A DRAM bitcell can be relatively simple in design compared to the bitcells of other types of computer memories. In one DRAM bitcell design, the bitcell comprises primarily a capacitor which stores an electrical charge, the level of which represents either a one or zero stored in the bitcell. As a consequence, DRAM bitcells may frequently take up less space than other bitcell designs.

The bitcell also typically includes a cell switch transistor which in an off state, inhibits discharge of the charge stored on the bitcell capacitor. In the on state, the switching transistor connects the bitcell capacitor to read/write circuitry which can read the charge level stored on the capacitor and hence read the bit value stored in the bitcell. The cell switch transistor also connects the bitcell capacitor to read/write circuitry which can store charge on the bitcell capacitor at a level which “writes” a bit value into the bitcell. Access to a DRAM bitcell for read and write commands may frequently be carried out more quickly than many other bitcell designs.

However, even in the off state of the cell switch transistor, the charge stored on the storage capacitor of the DRAM bitcell tends to leak from the bitcell such that the stored charge level tends to decay over time. If the bitcell is not read or otherwise refreshed before the charge level decays to a certain degree, such charge level decay can cause data loss and errors in reading the bit values stored in the bitcells.

In one DRAM PUF device proposal, an initial pattern of data is written into bitcells of the memory and the resultant charge levels are intentionally permitted to decay to produce a modified pattern of data. The content of the modified pattern is a function of the initial pattern written to the memory and random structural differences between bitcells which resulted from random variations in the fabrication processes. The random structural differences are intended to affect the manner in which the charges decay to produce the modified pattern which is intended to be unclonable.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating selected aspects of a system, employing physically unclonable function generation with direct twin cell activation in accordance with an embodiment of the present disclosure.

FIG. 2 depicts an example of a DRAM memory and memory controller, employing physically unclonable function generation with direct twin cell activation in accordance with an embodiment of the present disclosure.

FIGS. 3a, 3b each show an example of a twin cell of a pair of twin cells of a bitcell of the memory of FIG. 2 in greater detail.

FIG. 4 shows an example of a bitcell of the memory FIG. 2 employing the twin cells of FIGS. 3a, 3b, together with read amplifier circuitry.

FIG. 5 is a timing diagram depicting one example of write and read command operations in a read/write mode of the memory and memory controller of FIG. 2.

FIG. 6 depicts an example of the twin cell physically unclonable function mode logic of the multi-mode controller of FIG. 2.

FIG. 7 is a timing diagram depicting one example of structural bit state activation in a twin cell physically unclonable function mode of the memory controller of FIG. 2.

FIG. 8 depicts an example of operations of the twin cell physically unclonable function mode logic of the multi-mode controller of FIG. 2.

FIG. 9 is an example of an Open Bit Line (BL) architecture of a bitcell of a memory employing physically unclonable function generation with direct twin cell activation in accordance with an embodiment of the present disclosure.

### DESCRIPTION OF EMBODIMENTS

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In one prior DRAM PUF device proposal utilizing bitcells having a single cell in each bitcell, an initial pattern of data is written into the memory and the resultant charge levels are intentionally permitted to decay to produce a modified pattern of data. Such an approach may permit an off-the-shelf commodity memory to be used as a primary component of a PUF device. However, it is appreciated herein that this prior proposal necessarily includes an initial write function to write an initial set of data in the memory cells. It is further appreciated that decay time, that is the data charge destruction time, for a particular memory cell, may be dependent upon whether the memory cell is initialized in a write operation to a logical one value or a logical zero value. Thus, allowing for a proper decay time for a particular memory cell may depend upon knowing the initial bit state of the memory cell. However, in some PUF devices, the initial data written to the memory cells may not be known or available to the user. As a result, reliability of the DRAM PUF device may suffer.

Still further, recent memory devices employ an Open Bit Line (Open BL) architecture which utilizes a twin cell design for reliability. Prior PUF device designs intended for single cell bitcells may not be readily adapted to Open BL architecture memories having a twin cell bitcell.

In accordance with one embodiment of this disclosure, a physically unclonable function may be generated with direct twin cell activation in the absence of execution of a prior write command or refresh operation for the bitcell. For example, a structural bit state activation logic directly activates complementary structural bit states of a pair of twin cells of a bitcell in response to an activation command, without any intervening write bit states generated in the bitcell by write commands or refresh operations preceding the activated structural bit states.

As used herein, a write bit state is a bit state written to a twin cell or a bitcell by transferring charge in a write command or in a refresh operation. A write bit state results from the charge stored by a write command or a refresh operation and is readily changed by transferring an appropriate amount of charge to or from a twin cell or bitcell. in response to a write command.

In contrast, a structural bit state results from inherent structural differences between each twin cell of a pair of twin cells of a bitcell. These structural differences are generally not due to circuit design or layout differences but instead are due to unavoidable fabrication process variations in fabrication of each twin cell of the pair of twin cells. Accordingly these structural differences are generally not predictable but instead are random in nature in this embodiment. It is believed that these structural differences between each twin cell of a pair of twin cells of a bitcell may manifest themselves as one or more of cell capacitance differences, parasitic capacitance differences, threshold voltage differences, resistance differences or other circuit parameter differences between each twin cell of a pair of twin cells of a bitcell.

The complementary structural bit states activated by the structural bit state activation logic result from the structural differences between each twin cell of a pair of twin cells of a bitcell. Thus each structural bit state in the present embodiment does not result from charge or decayed charge previously stored by a write command or a refresh operation but is instead activated in the absence of a write command or refresh operation. A physically unclonable memory bit of the bitcell is in turn a function of the activated complementary structural bit states of the pair of twin cells of the bitcell.

In one aspect of the present description, structural bit state activation logic directly activates complementary structural bit states of a pair of twin cells of a bitcell without any intervening write bit states generated by write commands or refresh operations. As a result, a pattern of physically unclonable memory bits may be obtained from a twin cell DRAM memory having an Open or Folded BL architecture, for example, to generate a physically unclonable function, without initializing the memory with a pattern of write data. As such relying upon variable rates of decay of a distribution of write charges resulting from the initial pattern of write data may also be avoided.

Although described in connection with twin cell DRAM memories having an Open or Folded BL architecture, for example, it is believed that physically unclonable function generation with direct twin cell activation in accordance with the present description may be applied to other types of twin cell memory devices. Such devices in accordance with embodiments described herein can be used either in stand-alone memory circuits or logic arrays, or can be embedded in microprocessors and/or digital signal processors (DSPs). Additionally, it is noted that although systems and processes are described herein primarily with reference to microprocessor based systems in the illustrative examples, it will be appreciated that in view of the disclosure herein, certain aspects, architectures, and principles of the disclosure are equally applicable to other types of device memory and logic devices.

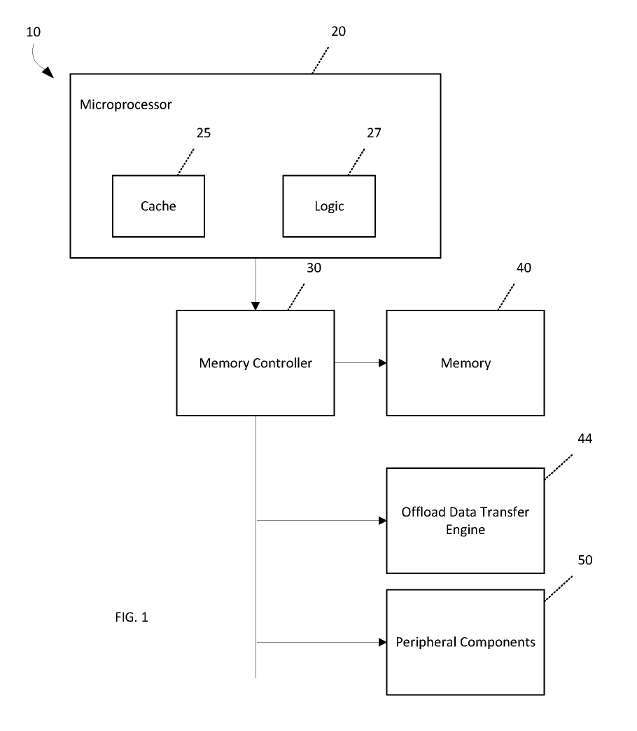

Turning to the figures, FIG. 1 is a high-level block diagram illustrating selected aspects of a system implemented, according to an embodiment of the present disclosure. System 10 may represent any of a number of electronic and/or computing devices, that may include a memory device. Such electronic and/or computing devices may include computing devices such as a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.) or component (e.g. system on a chip, processor, bridge, memory controller, memory, etc.). In alternative embodiments, system 10 may include more elements, fewer elements, and/or different elements. Moreover, although system 10 may be depicted as comprising separate elements, it will be appreciated that such elements may be integrated on to one platform, such as systems on a chip (SoCs). In the illustrative example, system 10 comprises a central processing unit or microprocessor 20, a memory controller 30, a memory 40 and peripheral components 50 which may include, for example, video controller, input device, output device, storage, network interface or adapter, battery, etc. . . . . The microprocessor 20 includes a cache 25 that may be part of a memory hierarchy to store instructions and data, and the system memory 40 may also be part of the memory hierarchy. Logic 27 of the microprocessor 20 may include one or more cores, for example. Communication between the microprocessor 20 and the memory 40 may be facilitated by the memory controller (or chipset) 30, which may also facilitate in communicating with the peripheral components 50. The system may include an offload data transfer engine 44 for direct memory data transfers.

Storage of the peripheral components 50 may be, for example, non-volatile storage, such as solid-state drives magnetic disk drives, optical disk drives, a tape drive, flash memory, etc.). The storage may comprise an internal storage device or an attached or network accessible storage. The microprocessor 20 is configured to write data in and read data from the memory 40. Programs in the storage are loaded into the memory and executed by the processor. A network controller or adapter enables communication with a network, such as an Ethernet, a Fiber Channel Arbitrated Loop, etc. Further, the architecture may, in certain embodiments, include a video controller configured to render information on a display monitor, where the video controller may be embodied on a video card or integrated on integrated circuit components mounted on a motherboard or other substrate. An input device is used to provide user input to the processor, and may include a keyboard, mouse, pen-stylus, microphone, touch sensitive display screen, input pins, sockets, or any other activation or input mechanism known in the art. An output device is capable of rendering information transmitted from the processor, or other component, such as a display monitor, printer, storage, output pins, sockets, etc. The network adapter may embodied on a network card, such as a Peripheral Component Interconnect (PCI) card, PCI-express, or some other input/output (I/O) card, or on integrated circuit components mounted on a motherboard or other substrate.

One or more of the components of the device 10 may be omitted, depending upon the particular application. For example, a network router may lack a video controller, for example. Any one or more of the memory devices 25, 40, and the other devices 10, 30, 50 may include a memory employing physically unclonable function generation in accordance with the present description.

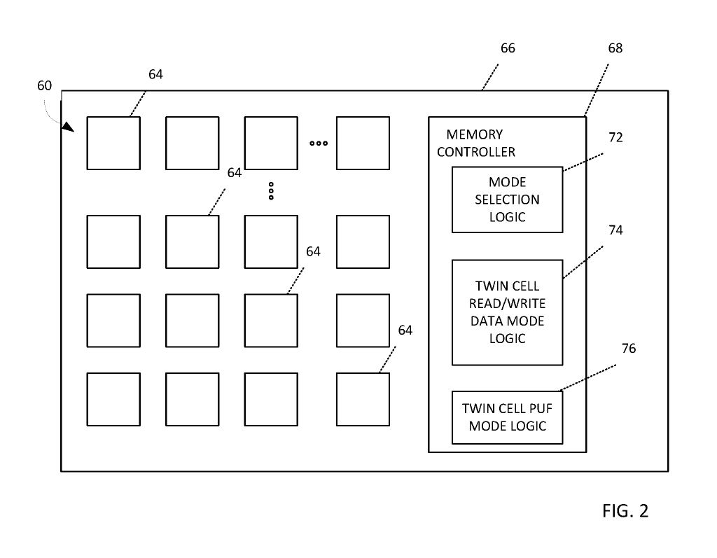

FIG. 2 shows an example of an array 60 of rows and columns of bitcells 64 of a DRAM memory 66 in accordance with one embodiment of the present description. The DRAM memory 66 may also include a row decoder, a timer device and I/O devices (or I/O outputs). Bits of the same memory word may be separated from each other for efficient I/O design. A multiplexer (MUX) may be used to connect each column to the required circuitry during a Read command. Another MUX may be used to connect each column to a write driver during a write command or refresh operation if a read/write mode is implemented. A memory controller 68 performs physically unclonable function operations in connection with the bitcells 64 of the memory 66. If the memory controller 68 is a multi-mode memory controller, it may also perform read commands, write commands, and refresh operations in a read/write mode, for example. As explained in greater detail below, write and refresh operations are not needed in a physically unclonable function generated with direct twin cell activation in accordance with the present description.

In one embodiment, the memory controller 68 is fabricated in one or more integrated circuit devices separate from the devices of the memory 66. In other embodiments, the memory controller 68 and the memory 66 may be fabricated in a single integrated circuit device.

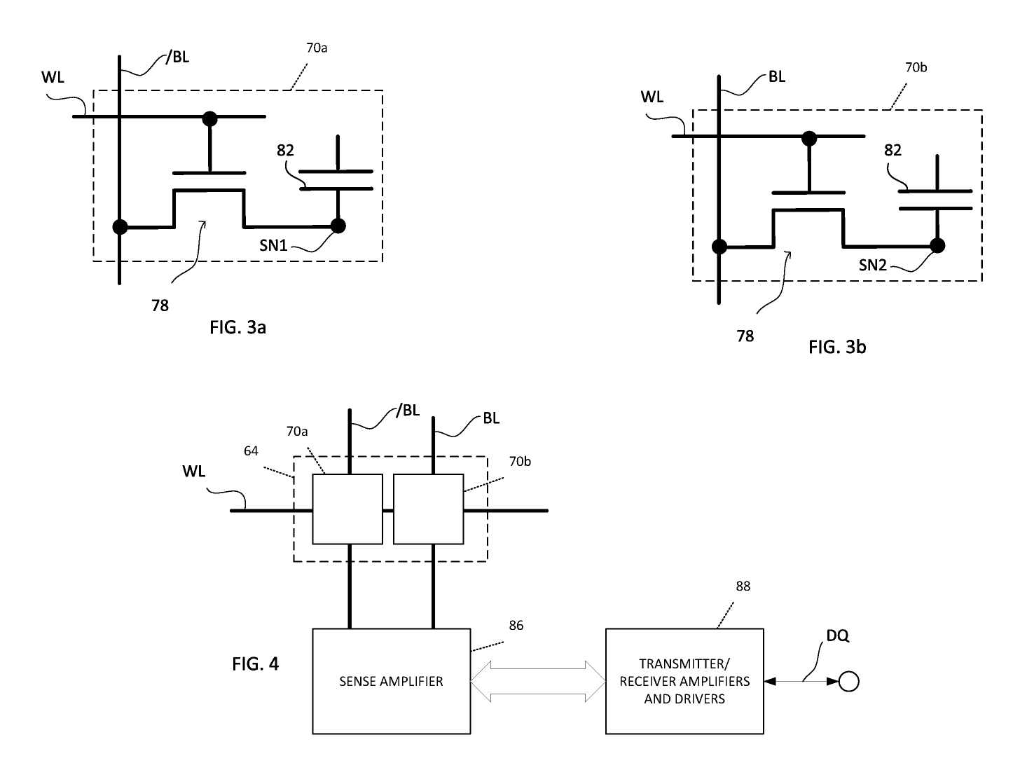

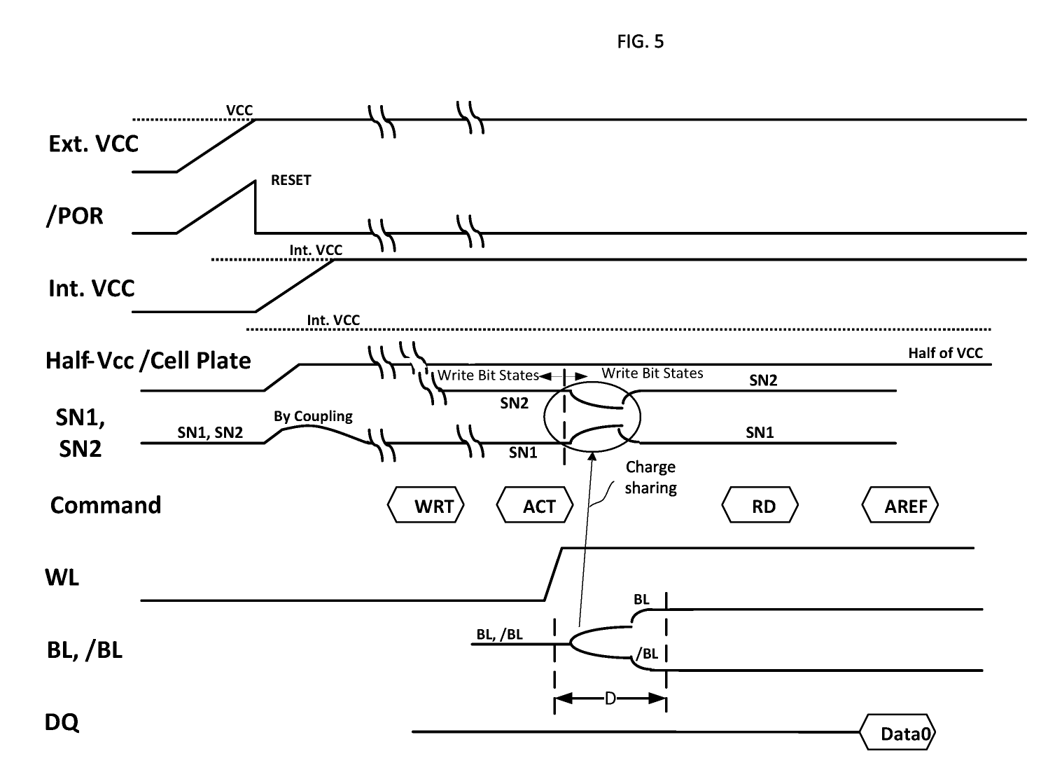

In the embodiment of FIG. 2, each bitcell 64 includes a pair of twin cells, such as the twin cell 70a (FIG. 3a) and the twin cell 70b (FIG. 3b) of the bitcell 64 (FIG. 4). The memory controller 68 includes a mode selection logic 72 configured to select various memory modes including a read/write memory mode and a physically unclonable function mode. However, it is appreciated that in other embodiments, the physically unclonable function device in accordance with the present description may operate solely as a physically unclonable function device such that other modes such as a read/write mode may be eliminated.

In a multi-mode device, a twin cell read/write data mode logic 74 is configured to perform memory operations of the read/write memory mode including, reading, writing and refreshing write bit states of the twin cells 70a, 70b of each bit cell 64 of the memory 66. As previously mentioned, as used herein, a write bit state is a bit state written to a twin cell or a bitcell by transferring charge in a write command or in a refresh operation.

To prevent errors and loss in the read/write mode, refresh circuitry of the twin cell read/write data mode logic 74 periodically refreshes the write charge levels stored in the bitcells. Thus, even if there is a long interval before a bitcell is read in the read/write mode, the refresh circuitry can maintain the stored charge level of the bitcell to preserve the bit data value of the bitcell until the data is needed.

In a read/write mode, a refresh operation of a bitcell includes reading the bitcell in a sense phase of a bitcell refresh cycle. The bit data value read during the sense phase of the refresh cycle may be latched if the read command destroys the write charge level stored in the bitcell in a prior write operation. The latched bit data value is then written back into the bitcell in a restoration phase of the refresh cycle, restoring the charge level to a level representing the read bit data value read from the bitcell, and completing the refresh cycle for that bitcell. The refresh cycle is periodically repeated to maintain the stored write charges at a minimum level to ameliorate data loss and read errors in the read/write mode.

A twin cell physically unclonable function mode logic 76 (FIG. 2) is configured to perform operations of the physically unclonable function mode, including directly activating structural bit states to produce physically unclonable data. In some embodiments, the physically unclonable function mode may further include generating a physically unclonable function such as a cryptographic function using the structural bit states of the activated pairs of twin cells of the memory 66 as described in greater detail below. The control circuit 68 is configured to perform the described operations using appropriate hardware, software or firmware, or various combinations thereof.

In the embodiment of FIG. 3a, a twin cell 70a of a pair of twin cells of a bitcell 64 (FIG. 4), comprises a cell switch transistor 78 and a storage node SN1 in the form of a storage capacitor 82. The storage node SN1 of the storage capacitor 82 is electrically coupled to a Not Bit Line (/BL) when the cell switch transistor 78 is in a conductive state. The conductive and nonconductive states of the cell switch transistor 78 are controlled by an input gate coupled to a word line WL.

In a similar manner, a twin cell 70b (FIG. 3b) of a pair of twin cells of a bitcell 64 (FIG. 4), comprises a cell switch transistor 78 and a storage node SN2 in the form of a storage capacitor 82. The storage node SN2 of the storage capacitor 82 is electrically coupled to a bit line BL when the cell switch transistor 78 is in a conductive state. The conductive and nonconductive states of the cell switch transistor 78 are controlled by an input gate coupled to a word line WL.

In a read/write data mode, the twin cells 70a, 70b have write bit states which are a function of charges stored in the twin cells in write commands, and refresh operations. Each twin cell 70a, 70b of a pair of twin cells of a bitcell 64 exhibits a write bit state which is the complement of the write bit state of the other twin cell of the bitcell. However, it is appreciated that in other embodiments, a physically unclonable function device in accordance with the present description may operate solely as an unclonable function device such that other modes such as a read/write mode and write bit states may be eliminated.

In one example of the read/write writable data mode, in this embodiment, a high voltage stored in the storage node SN2 by a write or refresh operation represents a logical one type write bit state stored in the twin cell 70b. Conversely, a low voltage stored in the storage node SN2 by a write or refresh operation represents a logical zero type write bit state stored in the twin cell 70b. Thus, in one example, a high voltage such as greater than a self-reference voltage is stored in the storage node SN2 by a write or refresh operation and represents a logical one type write bit state stored in the twin cell 70b. Conversely, a low voltage less than a self-reference voltage represents a logical zero type write bit state and is stored in the twin cell 70b by a write or refresh operation.

The voltage levels and hence the write bit states stored in the twin cells 70a, 70b of a bitcell 64 by a write or refresh operation are complementary. Thus, if a high voltage is stored in the storage node SN2 and represents a logical one type write bit state stored in the twin cell 70b by a write or refresh operation, a low voltage is stored in the storage node SN1 by a write or refresh operation and represents a logical zero type write bit state stored in the twin cell 70a. Conversely, if a low voltage is stored in the storage node SN2 by a write or refresh operation and represents a logical zero type write bit state stored in the twin cell 70b, a high voltage is stored in the storage node SN1 by a write or refresh operation and represents a logical one type write bit state stored in the twin cell 70a.

Thus, in the read/write data mode, the voltages exhibited by the storage nodes SN1, SN2 are a function of the charge levels of the electrical charges stored in the storage capacitors 82 of each twin cell 70a, 70b by a write or refresh operation. When the word line WL is active, the transistors 78 are conductive so that the voltages on the bit lines BL, /BL transition to complementary high and low voltages as a result of the complementary high and low voltage charges stored in the storage nodes SN2, SN1 of the twin cells 70b, 70a, respectively. Differences between the charge levels and hence the voltage levels of the storage nodes SN1, SN2 as exhibited on the bit lines /BL and BL, respectively, may be sensed by sense amplifier circuitry 86 (FIG. 4) when the word line WL is made active by the memory controller 68 (FIG. 2) which controls the word line WL in the read/write data mode. After a timing delay, a logical state is latched by the sense amplifier 86 as a function of the differences of the sensed voltages exhibited on the bit lines /BL and BL. Thus, in one embodiment, the sense amplifier may be a differential amplifier which senses a difference in voltages and provides a corresponding output. Alternatively, the sense amplifier may be a nondifferential amplifier operating in a current mode. Other types of sense amplifiers may be utilized, depending upon the particular application.

An output of the sense amplifier circuitry 86 is amplified by amplifiers 88 having an input/output signal line labeled DQ in FIG. 4 in which the signal line DQ exhibits the write bit state of the bitcell 64 read in a read command. Conversely, a write signal applied to the signal line DQ by a write or refresh operation stores a write bit state in the bitcell 64.

In the illustrated embodiment, the array 60 (FIG. 2) is a bank of bitcells 64 in which the bank is subdivided into a plurality of bitcell array sections. A memory may have many such banks of bitcell array sections. The number of bitcells 64 in each section may range from as few as tens, to as many as millions or billions or more, depending upon the particular application. Adjacent each section of bitcells is a circuit area includes the sense amplifiers 86 (FIG. 4) and other amplifiers and driver 88 for reading data from or writing data to, or refreshing the bitcells of the adjacent section. It is appreciated that the particular arrangement of bitcells 64 and amplifier/driver circuitry may vary, depending upon the particular application.

FIG. 5 is a timing diagram depicting an example of read and write commands directed to a twin cell bitcell 64 (FIG. 4) in a twin cell read/write data mode of the memory controller 68 (FIG. 2). The twin cell read/write data mode timing diagram depicted in FIG. 5 is substantially similar to that of conventional read and write commands in a conventional DRAM and conventional memory controller which have not been modified in accordance with the present description to also have a selectable twin cell physically unclonable function mode as described herein.

Prior to application of power to the memory 66, the twin cells 70a, 70b of the bitcell 64 are inactive and the voltages of the storage nodes SN1, SN2 are discharged to ground in this embodiment. As an external power signal (VCC in this example) is applied to the memory 66, a power-on-reset signal/POR is active. Accordingly, an internal power signal, Int. VCC, are available. In connection with the power-up sequence, voltages or charges may be coupled to the storage nodes SN1, SN2 but these voltages or charges may be discharged again to ground prior to the write operations as shown in FIG. 5 in this example.

A write command (WRT) is issued to the memory such that the twin cells 70a, 70b are in complementary write bit states. As used herein, a write bit state is a bit state written to a twin cell or a bitcell by transferring and storing charge in a write command or in a refresh operation. A write bit state is readily changed by transferring an appropriate amount of charge to or from a twin cell or bitcell. in response to a write command or refresh operation. In the example of FIG. 5, a high voltage charge is stored in the storage node SN2 of the twin cell 70b which writes a logical one type write bit state to the twin cell 70b. Conversely, a low voltage charge is stored in the complementary storage node SN1 of the twin cell 70a which writes a complementary logical zero type write bit state to the twin cell 70a as shown in FIG. 5.

Receipt of an activate (ACT) command from the memory controller opens a row of bitcells 64 of the memory 66 for a refresh operation, another write command or a read command. Accordingly, in the timing diagram of FIG. 5 depicting the read/write mode, upon receipt of an activation (ACT) command in anticipation of a subsequent read (RD) command, the twin cells 70a, 70b remain in complementary write bit states to be read by the read command.

In the example of FIG. 5, the storage nodes SN2, SN1 are in complementary high and low write bit states, respectively. In response to the activation (ACT) command, the bit states of the bit lines BL, /BL will exhibit complementary, determinate write bit states as a function of the complementary write charges stored in the storage nodes SN2, SN1, respectively of twin cells 70a, 70b of the bitcell 64 as shown in FIG. 5. Accordingly, in response to the activation (ACT) command, the Word Line (WL) is active which turns on the transistor 78 of the twin cell 70b of FIG. 3b, which couples for charge sharing (as represented by an arrow labeled “charge sharing”) the high voltage charge at the storage node SN2 to the Bit Line (BL) such that the voltage on the Bit Line (BL) rises to the logical one value. Similarly, the active Word Line (WL) also turns on the transistor 78 of the twin cell 70a of FIG. 3a, which couples the complementary low voltage charge at the storage node SN1 to the Not Bit Line (/BL) such that the voltage on the Not Bit Line (/BL) falls to the complementary low zero value.

The differential voltage levels of the storage nodes SN1, SN2 as exhibited on the bit lines/BL and BL, respectively, through the active transistors 78 of the twin cells 70a, 70b, respectively, are sensed by sense amplifier circuitry 86 (FIG. 4). After a timing delay D, a logical state (logical one in this example) is latched by the sense amplifier 86 as a function of the differences of the sensed voltages exhibited on the bit lines/BL and BL. Upon receipt of a read (RD) command, the latched output of the sense amplifier circuitry 86 as amplified by the amplifiers 88 and provided by the input/output signal line labeled DQ, is read as the data Data0 of the bitcell 64 in response to the read command. The write bit states of the twin cells 70a, 70b may be retained by a refresh (AREF) operations.

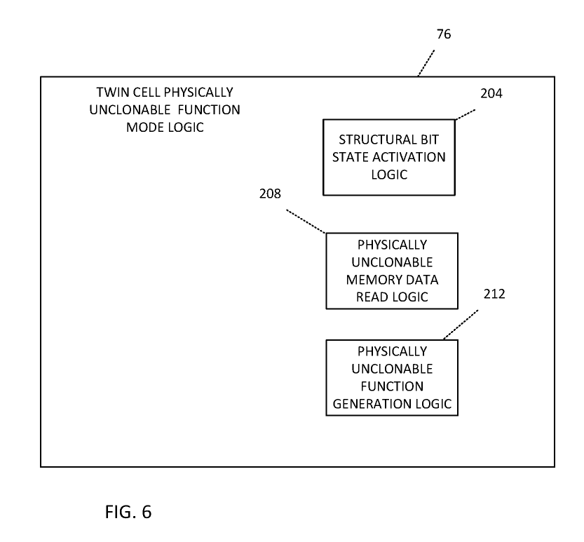

The above described read/write mode may be eliminated in some embodiments. Thus, in some embodiments, the memory 66 and memory controller 68 may perform exclusively in a twin cell physically unclonable function mode. As shown in FIG. 6, the twin cell physically unclonable function mode logic 76 includes structural bit state activation logic 204 configured to be in the twin cell physically unclonable function mode, activate complementary structural bit states of a pair of twin cells of a bitcell directly from no-write bit states of the pair of twin cells of the bitcell in the absence of write operations in the physically unclonable function mode. As explained below, a “no-write” bit state as that term is used herein, is a bit state which occurs in a twin cell in the absence of stored charges from a write command or refresh operation. Accordingly, in one embodiment, the structural bit state activation logic 204 activates complementary structural bit states of a pair of twin cells of a bitcell without any intervening write bit states generated by write commands or refresh operations. The physically unclonable function mode logic 76 is further configured to, in the physically unclonable function mode, power-up and maintain power to the memory in the absence of write operations so that the pair of twin cells of the bitcell have the no-write bit states before being activated to the complementary structural bit states by the structural bit state activation logic 204.

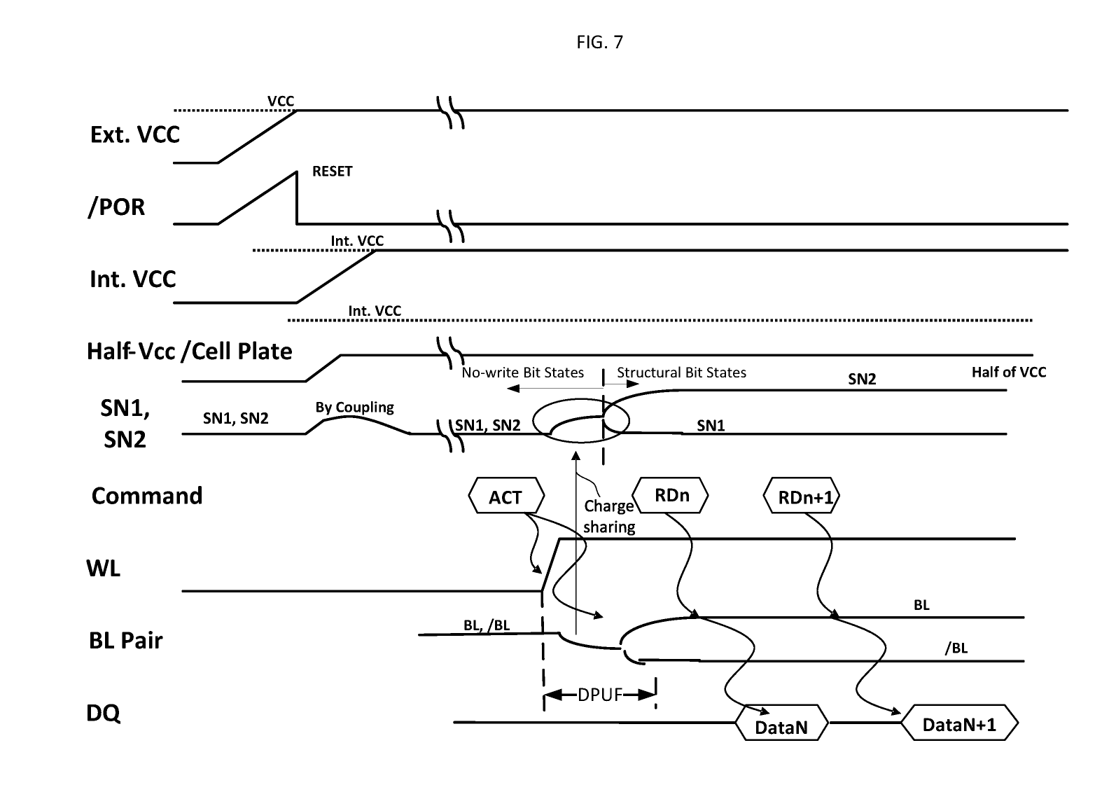

FIG. 7 is a timing diagram depicting an example of a structural bit state activation command directed to a twin cell bitcell 64 (FIG. 4) following power-up of the memory 66 in a twin cell physically unclonable function mode of the memory controller 68 (FIG. 2) without the necessity of any prior write commands or refresh operations. The structural bit state activation command is followed by read commands which read the activated structural bit states produced without the necessity of any write commands or refresh operations. Thus the structural bit state activation logic 204 provides complementary structural bit states of a pair of twin cells of a bitcell in the physically unclonable function mode without any prior write commands or refresh operations in this embodiment.

Prior to application of power to the memory 66 and in a manner similar to the power-up phase of the read/write mode timing diagram of FIG. 5, the twin cells 70a, 70b of the bitcell 64 are inactive and the voltages of the storage nodes SN1, SN2 are discharged to ground in this embodiment. As an external power signal (VCC in this example) is applied to the memory 66, a power-on-reset signal/POR is active. Accordingly, an internal power signal, Int. VCC is available.

In connection with the power-up sequence, stray voltages or charges may be coupled to the storage nodes SN1, SN2 but these stray voltages or charges may be discharged again to ground as shown in FIG. 7 in this example. Accordingly, in the physically unclonable function mode, imposition of a sufficiently long wait state to ensure discharge of the storage nodes SN1, SN2 to ground may be appropriate. Such a wait state may be initiated in a power-up sequence of the physically unclonable function mode to ensure that any cell write data charges of a prior read/write mode if any, are discharged to ground in preparation for the generation of complementary structural bit states in the physically unclonable function mode. Although the physically unclonable function mode is described herein in connection with an initial discharge of the twin cell storage nodes to ground, it is appreciated that the storage nodes of the twin cells may be initialized at other matching voltage levels in other embodiments of the physically unclonable function mode, depending upon the particular application.

Prior to activation of the twin cells 70a, 70b in the physically unclonable function mode, the bit states of the inactive twin cells 70a, 70b are each in matching “no-write” bit states which in the illustrated embodiment may both represent a logical zero value, for example. As used herein, a no-write bit state is a bit state which occurs in a twin cell in the absence of stored charges from a write command or refresh operation. For example, a no-write state may result as storage nodes of both twin cells of a bitcell discharge to ground as shown in FIG. 7 in the absence of write commands and refresh operations and prior to an activation command which activates the bitcell. In contrast to a no-write bit state, a write bit state is a bit state written to a twin cell or a bitcell by transferring and storing charge in a write command or in a refresh operation. A write bit state is readily changed by transferring an appropriate amount of charge to or from a twin cell or bitcell. in response to a write command or refresh operation.

Thus, in this example of FIG. 7, prior to receipt of a structural bit state activate (ACT) command, the voltage levels of the storage nodes SN1, SN1 of the inactive twin cells 70a, 70b are both discharged to ground in matching “no-write” bit states of the inactive twin cells 70a, 70b. Receipt of a structural bit state activate (ACT) command from the memory controller 68, opens a row of bitcells 64 of the memory 66 to permit them to exhibit structural bit states in the absence of write charges by a write command or a refresh operation. As a result, the no-write bit states of twin cells 70a, 70b switch to complementary, determinate structural bit states which are exhibited by the now active twin cells 70a, 70b of the bitcell 64 as shown in FIG. 7.

Thus, upon receipt of a structural bit state activate (ACT) command, the Word Line (WL) is active which turns on the transistor 78 of the twin cell 70b of FIG. 3b, which couples for charge sharing (as represented by the arrow labeled “charge sharing”) the storage node SN2 to the Bit Line (BL). Since the storage node SN2 is discharged to ground prior to activation of the Word Line (WL), upon turning on the transitory 78, the voltage of the Bit Line (BL) initially falls and the voltage of the storage node SN2 initially rises as indicated in FIG. 7. Moreover, since no write charges by a write command or a refresh operation have been directed to the twin cell 70b before or after assertion of the structural bit state activate (ACT) command, the bit state of the Bit Line (BL) continues to be a no-write bit state in which the voltage is falling toward a logical zero value.

Similarly, the active Word Line (WL) also turns on the transistor 78 of the twin cell 70a of FIG. 3a, which couples the storage node SN1 to the complementary Not Bit Line (/BL). Since the storage node SN1 is discharged to ground prior to activation of the assertion of the Word Line (WL), upon turning on the transitory 78, the voltage of the Not Bit Line (/BL) also initially falls and the voltage of the storage node SN1 also initially rises as indicated in FIG. 7. Again, since no write charges by a write command or a refresh operation have been directed to the twin cell 70a before or after assertion of the structural bit state activate (ACT) command, the bit state of the Not Bit Line (/BL) also continues to be a no-write bit state in which the voltage is also falling toward a logical zero value.

However, it is appreciated that there are inherent structural differences between each twin cell 70a, 70b of the pair of twin cells of the bitcell 64. These structural differences are generally not due to circuit design or layout differences but instead are due to unavoidable fabrication process variations in fabrication of each twin cell of the pair of twin cells. Accordingly these structural differences are generally not predictable but instead are random in nature in this embodiment. It is believed that these structural differences between each twin cell 70a, 70b of the pair of twin cells of a bitcell 64 may manifest themselves as one or more of cell capacitance differences, parasitic capacitance differences, threshold voltage differences, resistance differences or other circuit parameter differences between each twin cell 70a, 70b of the pair of twin cells of a bitcell 64.

Accordingly, as the voltages on the storage nodes SN2, SN1 initially rise together as indicated in FIG. 7 following activation of the Word Line (WL) in response to the structural bit state activation (ACT) command, the voltages on the storage nodes SN2, SN1 subsequently diverge as shown in FIG. 7 due to the structural differences between the twin cells 70a, 70b of the pair of twin cells of a bitcell 64 as shown in the example of FIG. 7, notwithstanding that no write by a write command or a refresh operation has been directed to the twin cells 70a, 70b before or after assertion of the structural bit state activate (ACT) command. In a similar manner, as the voltages on the Bit Line (BL) and Not Bit Line (/BL) (coupled to the storage nodes SN2, SN1, respectively, by the conductive transistors 78) initially fall as indicated in FIG. 7 following activation of the Word Line (WL) in response to the structural bit state activation (ACT) command, the voltages on the Bit Line (BL) and Not Bit Line (/BL) subsequently diverge as well as shown in FIG. 7 due to the structural differences between the twin cells 70a, 70b of the pair of twin cells of a bitcell 64 as shown in the example of FIG. 7, notwithstanding that no write by a write command or a refresh operation has been directed to the twin cells 70a, 70b before or after assertion of the structural bit state activate (ACT) command.

Thus, the voltage on the storage node SN2 and the voltage on the Bit Line (BL), driven by the sense amplifier 86, may diverge from the respective voltages on the complementary storage node SN1 and the complementary Not Bit Line (/BL), by rising, for example, in the example depicted in FIG. 7. Conversely, the voltage on the storage node SN1 and the voltage on the Not Bit Line (/BL), driven by the sense amplifier 86, may diverge from the respectively voltages on the complementary storage node SN2 and the complementary Bit Line (BL), by falling, for example.

As noted above, the voltages on the storage nodes SN2 and SN1 subsequently diverge and the voltages on the bit lines BL and/BL subsequently diverge as shown in FIG. 7 due to the structural differences between the twin cells 70a, 70b of the pair of twin cells of a bitcell 64. Because the structural differences between the twin cells 70a, 70b of the pair of twin cells of a bitcell 64 are random, the voltages on the storage node SN2 and Bit Line (BL) driven by the sense amplifier 86, may diverge from the voltages on the complementary storage node SN1 and Not Bit Line (/BL) by falling, for example instead of rising as depicted in the example of FIG. 7. In a similar manner, the voltages on the complementary storage node SN1 and the Not Bit Line (/BL), driven by the sense amplifier 86, may diverge from the corresponding voltages on the storage node SN2 and the Bit Line (BL) by rising for example instead of falling as depicted in the example of FIG. 7.

Thus, whether the voltages on the storage node SN2 and the Bit Line (BL) rise and the voltages on the complementary storage node SN1 and the Not Bit Line (/BL) fall, or the reverse occurs and the voltages on the storage node SN2 and the Bit Line (BL) fall and the voltages on the complementary storage node SN1 and the Not Bit Line (/BL) rise following the assertion of the structural bit state activate (ACT) command in which no write by a write command or a refresh operation is directed to the twin cells 70a, 70b, is random in nature due to the random nature of the structural differences caused by the random process variations in the fabrication of the twin cells 70a, 70b of the pair of twin cells of a bitcell 64. In this manner, random and complementary structural bit states of the twin cells 70a, 70b of the pair of twin cells of a bitcell 64 are produced in the physically unclonable function mode of the memory 66 and memory controller 68.

It is noted that the structural differences between the twin cells 70a, 70b may be relatively small. Accordingly, the sensitivity of the sense amplifier 86 is such that it can detect the relatively small circuit operational differences between the twin cells 70a, 70b caused by the structural differences between the twin cells 70a, 70b. In one embodiment, process variations in the fabrication of the sense amplifiers are controlled so that circuit operational differences between the twin cells 70a, 70b caused by structural differences between the twin cells 70a, 70b due to fabrication process variations, predominate over any circuit operational differences within the sense amplifier 86 caused by structural differences in the circuitries of each sense amplifier due to fabrication process variations. Thus, the fabrication process may be controlled to reduce process variations in the fabrication of the sense amplifier as they affect circuit parameters such as Vt and Leff, for example. In addition, sufficient time may be provided following assertion of the structural bit state activation (ACT) to allow the complementary structural bit states to manifest themselves and stabilize before asserting a read command as described below.

In the embodiment of FIG. 7, the sense amplifier 86 may be configured to provide a timing delay DPUF following assertion of the structural bit state activation (ACT) before the logical value of the structural bit state is latched by the sense amplifier 86 as a function of the differences of the sensed voltages exhibited on the bit lines/BL and BL. In the physically unclonable function mode, such a delay DPUF may be, for example, one and a half times, double or triple, for example, the delay D (FIG. 5) of a typical read/write mode, to allow the complementary structural bit states to manifest themselves and stabilize before asserting a read command in a physically unclonable function mode of FIG. 7. Other delay periods may be asserted, depending upon the particular application.

In one embodiment, the activate (ACT) command for structural bit state activation as depicted in the diagram of FIG. 7 may be the same or similar to an activate (ACT) command as described above for the read/write mode as depicted in the diagram of FIG. 5, in that the activate command in both modes activates a word line (WL) to turn on the transistors of the twin cells. However, in the structural bit state activation as depicted in the diagram of FIG. 7, the delay DPUF may be longer than the delay D depicted in the read/write mode of FIG. 5. If so, in one embodiment, a new Mode Register Set (MRS) may be utilized to specify the delay DPUF in connection with the activate (ACT) command in the structural bit state activation as depicted in the diagram of FIG. 7. In a similar manner, a Mode Register Set (MRS) may be utilized to specify the delay D in connection with the activate (ACT) command in the read/write mode as depicted in the diagram of FIG. 5. In some embodiments, the delay DPUF in the structural bit state activation as depicted in the diagram of FIG. 7, may be the same as the delay D depicted in the read/write mode of FIG. 5. It is further appreciated that other techniques may be utilized to set delays as appropriate for various modes of operation.

As shown in FIG. 6, the twin cell physically unclonable function mode logic 76 further includes read logic 208 configured to read physically unclonable memory data including a plurality of physically unclonable memory bits from activated twin cells of the memory 66. Each physically unclonable memory bit is represented by a physically unclonable bit state of a bitcell 64. In the illustrated embodiment, the read logic 208 includes the sense amplifiers 86 which have inputs coupled to the bit line BL, /BL, signal lines of each activated pair of twin cells 70a, 70b as shown in FIG. 4. Each sense amplifier 86 is configured to read a physically unclonable memory bit from an activated pair of twin cells 70a, 70b and latch the physically unclonable memory bit as a function of structural bit states of the pair of activated twin cells 70a, 70b of the memory.

Upon receipt of a read command, the latched output of the sense amplifier circuitry 86 as amplified by the amplifiers 88 and provided by the input/output signal line labeled DQ, is read in response to the read command. Accordingly, upon receipt of a first read (RDn) command for a first column N of bitcells 64, the latched output DataN of the sense amplifier 86 for that column N is read for the bitcell 64 of the column N having the active word line WL. The latched output DataN is determined by the divergent, differential voltage levels of the storage nodes SN1, SN2 as exhibited in FIG. 7 on the bit lines/BL and BL, respectively, through the active transistors 78 of the twin cells 70a, 70b, respectively, and are sensed by sense amplifier circuitry 86 (FIG. 4) which latches a logical value DataN as determined by the structural bit states of the activated bitcell 64 of the column N. Thus, in the twin cell physically unclonable function mode of FIG. 7, the output DQ in response to the read (RDn) command, exhibits a physically unclonable memory bit DataN which represents a physically unclonable bit state of the activated bitcell 64 of the column N of bit cells 64.

Upon receipt of another read (RDn+1) command for another column N+1 of bitcells 64, the latched output DataN+1 of the sense amplifier 86 for that column N+1 is read for the bitcell 64 of the column N+1 having the active word line WL. The latched output DataN+1 is determined by the divergent, differential voltage levels of the storage nodes SN1, SN2 as exhibited in FIG. 7 on the bit lines/BL and BL, respectively, through the active transistors 78 of the twin cells 70a, 70b, respectively, and are sensed by sense amplifier circuitry 86 (FIG. 4) which latches a logical value DataN+1 as determined by the structural bit states of the activated bitcell 64 of the column N+1. Thus, in the twin cell physically unclonable function mode of FIG. 7, the output DQ in response to the read (RDn+1) command, exhibits a physically unclonable memory bit DataN+1 which represents a physically unclonable bit state of the activated bitcell 64 of the column N+1 of bit cells 64.

Whether a physically unclonable bit state of a particular bitcell 64 is a logical one or logical zero, is a function of the random nature of the structural differences caused by the random process variations in the fabrication of the twin cells 70a, 70b of the pair of twin cells of a bitcell 64. However, the structural differences caused by the random process variations in the fabrication of the twin cells 70a, 70b of the pair of twin cells of a bitcell 64 remain fixed. Hence, a subsequent read command repeatedly directed to the same bitcell 64 can reliably produce the same value of the physically unclonable memory bit read that same particular bitcell 64 in each read command. Thus, if a read command directed to a particular bitcell 64 in the twin cell physically unclonable function mode produces a logical one value, for example, a subsequent read command directed to the same particular bitcell 64 in the twin cell physically unclonable function mode can again produce a logical one value since the physical differences between the twin cells of the bitcell which caused the structural bit states remain unchanged. Accordingly, although the pattern of logical ones and zeros produced by a memory 66 in the twin cell physically unclonable function mode is random in nature, the same pattern of logical ones and zeros can be reliably reproduced by the same set of bitcells 64 of memory 66 in response to each read command directed to the same set of bitcells in the twin cell physically unclonable function mode. Moreover, no refresh operations are needed in the physically unclonable function mode to maintain the complementary structural bit states of a pair of twin cells since those complementary structural bit states result in the physically unclonable function mode, from permanent structural differences between the twin cells instead of stored charge which can decay absent refresh operations.

It is appreciated that one or more bitcells may not reliably produce a consistent physically unclonable function memory bit value. If so, the memory 66 may be tested to identify unreliable bitcells in the physically unclonable function mode and the physically unclonable memory bit outputs of those bitcells deemed unreliable may be filtered out by the read logic 208 in the physically unclonable function mode.

It is noted that in one embodiment, the pattern of logical ones and zeros may be produced by the memory 66 in response to read commands in the twin cell physically unclonable function mode, without any write commands or refresh operations to the memory 66 in the twin cell physically unclonable function mode notwithstanding long periods with no read commands. Prior proposed physically unclonable functions utilizing a prior DRAM PUF memory have often included writing an initial pattern of ones and zeroes into a DRAM memory and allowing the resultant charges to decay over time to produce an altered pattern of ones and zeros. However, it is appreciated that decay time, that is the data charge destruction time, for a particular memory cell, may be dependent upon whether the memory cell in the prior DRAM PUF scheme is initialized in a write operation to a logical one value or a logical zero value. Thus, allowing for a proper decay time for a particular memory cell in the prior DRAM PUF scheme may depend upon knowing the initial bit state of the memory cell. However, in some prior DRAM PUF devices, the initial data written to the memory cells may not be known or available to the user. As a result, reliability of the prior DRAM PUF device may suffer.

Still further, recent memory devices may employ an Open Bit Line (Open BL) architecture which utilizes a twin cell design for reliability. Prior DRAM PUF device designs intended for single cell bitcells may not be readily adapted to memories having a twin cell bitcell architecture such as Open Bit Line or Folded Bit Line architectures.

As shown in FIG. 6, the twin cell physically unclonable function mode logic 76 further includes physically unclonable function generation logic 212 which is configured to generate a physically unclonable function in response to a random but reproducible pattern of physically unclonable memory bits received from the memory 66 in the twin cell physically unclonable function mode.

In one embodiment, the physically unclonable function (PUF) generated by the physically unclonable function generation logic 212 may generate a cryptographic key which determines the functional output of a cryptographic algorithm such as an encryption algorithm, for example. Thus, the random pattern of physically unclonable memory bits received from the memory 66 in the twin cell physically unclonable function mode may provide a key used by the physically unclonable function generation logic 212 to specify the transformation of text into encrypted text, for example. Similarly, in a decryption algorithm, the random pattern of physically unclonable memory bits received from the memory 66 in the twin cell physically unclonable function mode may provide a key used to specify the transformation of encrypted text back into unencrypted text, for example.

In another embodiment, the random pattern of physically unclonable memory bits received from the memory 66 in the twin cell physically unclonable function mode may provide a key used for device identification or digital signature authentication. In yet another embodiment, the random pattern of physically unclonable memory bits received from the memory 66 in the twin cell physically unclonable function mode may provide a key used for message authentication codes to ensure authenticity. It is appreciated that the physically unclonable function generation logic 212 may be configured to generate other physically unclonable functions including other security protection functions, in response to a random pattern of physically unclonable memory bits received from the memory 66 in the twin cell physically unclonable function mode, depending upon the particular application. It is further appreciated that some embodiments may eliminate a physically unclonable function generation logic 212 and be utilized to produce a set of physically unclonable memory bits without further function generation such as a cryptographic function, for example.

The length of the pattern of logical ones and zeros of a pattern of physically unclonable memory bits produced by a memory 66 in the twin cell physically unclonable function mode may vary depending upon the particular application. For example, the random pattern of physically unclonable memory bits received from the memory 66 in the twin cell physically unclonable function mode may be used to provide a cryptographic secure key store. In many applications, a degree of entropy provided by a 256 bit key, is useful. The length of the pattern of logical ones and zeros of a pattern of physically unclonable memory bits read from the memory 66 to ensure a 256 bit degree of entropy for a key, may be a function of one or more of entropy extraction, PUF error rate and error correction code (ECC) data. In one test, a generated key that has 256 bits of entropy, is computationally indistinguishable from a 256-bit random key. It is usually assumed that an attacker has access to the ECC data. Accordingly, a pattern of PUF memory bits from a few to several Kilobytes (KB) in length is suitable for a number of PUF applications. It is appreciated that the pattern length may vary, depending upon the particular application.

It is further appreciated that in some embodiments, one or more of the read logic 208 and the unclonable function generation logic 212 may be eliminated. For example, in some physically unclonable function device applications, it is sufficient to produce a string of random bits to be latched in suitable registers without further generation of ancillary functions such as cryptographic functions using the string of random bits for example. It is further appreciated that in other embodiments in which other modes such as a read/write mode may be eliminated, memory commands such as read, write and activation as depicted in FIG. 5 may be eliminated.

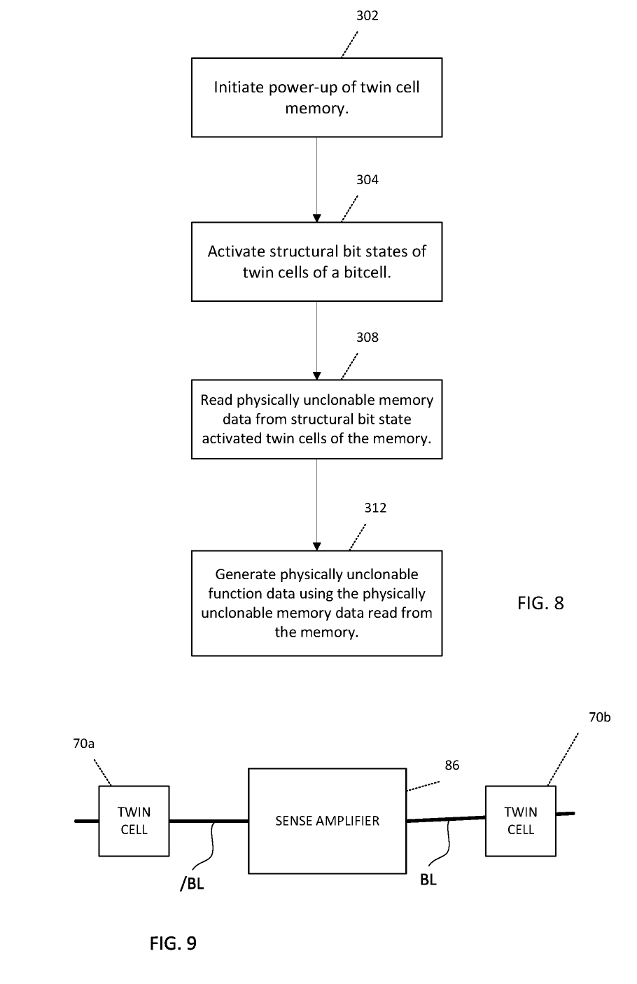

FIG. 8 depicts one example of operations of the twin cell physically unclonable function mode logic 76 (FIG. 6) and the memory 66 in the twin cell physically unclonable function mode. In this embodiment, the physically unclonable function mode is initiated by initiating (block 302) a power-up sequence. Prior to application of power to the memory 66, the twin cells 70a, 70b of the bitcell 64 are inactive and the voltages of the storage nodes SN1, SN2 are discharged to ground in this embodiment. As an external power signal (VCC in this example) is applied to the memory 66, stray voltages or charges may be coupled to the storage nodes SN1, SN2 but these stray voltages or charges may be discharged again to ground as shown in FIG. 7 in this example. Accordingly, in the physically unclonable function mode, imposition of a sufficiently long wait state to ensure discharge of the storage nodes SN1, SN2 to ground may be appropriate.

Prior to activation of the twin cells 70a, 70b in the physically unclonable function mode, the bit states of the inactive twin cells 70a, 70b are each in matching “no-write” bit states which in the illustrated embodiment may both represent a logical zero value, for example. In this example, the structural bit state activation logic 204 (FIG. 6) in the physically unclonable function mode, activates (block 304) structural bit states from each pair of twin cells 70a, 70b (FIGS. 3a, 3b) of the plurality of bitcells 64 (FIG. 2) of the memory 66. In the physically unclonable function mode of this embodiment, there are no write commands or refresh operations during either the power-up phase (block 302) or the structural bit state activation phase (block 304). Accordingly, in this embodiment, since no write charges by a write command or a refresh operation have been directed to the twin cells 70a, 70b before, during or following assertion of the structural bit state activate (ACT) command, the bit states of the bit lines BL, /BL continue in no-write bit states in which the voltages are falling toward a logical zero value as shown in FIG. 7.

As noted above, the no-write bit states subsequently diverge directly into complementary, structural bit states due to structural differences between the twin cells 70a, 70b of the pair of twin cells of a bitcell 64 notwithstanding that there have been no write operations. Thus, the voltages on the storage nodes SN2, SN1 subsequently diverge from each other and the voltages on the Bit Line (BL) and Not Bit Line (/BL) subsequently diverge from each other as shown in FIG. 7 due to the structural differences between the twin cells 70a, 70b of the pair of twin cells of a bitcell 64 notwithstanding that there have been no write operations. Because the structural differences between the twin cells 70a, 70b of the pair of twin cells of a bitcell 64 are random, the voltage on the storage node SN2 driven by the sense amplifier 86, may diverge from the voltage on the complementary storage node SN1 by rising, for example, and the voltage on the Bit Line (BL) driven by the sense amplifier 86, may diverge from the voltage on the complementary Not Bit Line (/BL) by rising, for example as depicted in FIG. 7. If the structural differences between the twin cells 70a, 70b of the pair of twin cells of a bitcell 64 happen to be reversed from the example depicted in FIG. 7, the voltage on the storage node SN2 driven by the sense amplifier 86, may diverge from the voltage on the complementary storage node SN1 by falling, for example, and the voltage on the Bit Line (BL) driven by the sense amplifier 86, may diverge from the voltage on the complementary Not Bit Line (/BL) by falling, for example. The divergent voltages on the storage nodes SN2, SN1 and the divergent voltages on the Bit Line (BL) and the Not Bit Line (/BL), represent complementary structural bit states of the pair of activated (block 304) twin cells 70a, 70b. Thus, if the voltage on one of the Bit Line (BL) and the Not Bit Line (/BL) represents a logical one state, the voltage on the other of the Bit Line (BL) and the Not Bit Line (/BL) represents a complementary logical zero state, depending upon the structural differences of the pair of activated (block 304) twin cells 70a, 70b.

The read logic 208 (FIG. 6) reads (block 308) physically unclonable memory data which includes a pattern of physically unclonable memory bits from the bitcells 64 of the memory 66. Each physically unclonable memory bit is output on an output line DQ (FIG. 4) and represents a physically unclonable bit state of a bitcell 64 being read by the read logic 208. Each physically unclonable bit state of a bitcell 64 being read is in turn a function of the complementary structural bit states of the pair of activated twin cells 70a, 70b as exhibited by the divergent voltages on the Bit Line (BL) and the Not Bit Line (/BL) in the example of FIG. 7.

The physically unclonable function generation logic 212 (FIG. 6) generates (block 312, FIG. 8) a physically unclonable function in response to the random pattern of physically unclonable memory bits read (block 308) from the memory 66 in the twin cell physically unclonable function mode. In one embodiment, the physically unclonable function (PUF) generated by the physically unclonable function generation logic 212 may generate a cryptographic key which determines the functional output of a cryptographic algorithm such as an encryption algorithm, for example. It is appreciated that other physically unclonable functions may be generated by the physically unclonable function generation logic 212, depending upon the particular application. Other embodiments may lack physically unclonable function generation logic 212.

The embodiment of FIG. 4 depicts an example of a pair of twin cells 70a, 70b in a Folded Bit Line (BL) architecture. FIG. 9 depicts an example of a pair of twin cells 70a, 70b in an Open Bit Line (BL) architecture employing physically unclonable function generation with direct twin cell activation in accordance with an embodiment of the present disclosure. It is appreciated that other twin cell architectures may be utilized, depending upon the particular application.

It is seen from the above, that a twin cell architecture memory may be employed in physically unclonable function generation may have substantially reduced complexity and size due to direct twin cell activation. For example, the twin cells 70a, 70b of each bitcell may be relatively small, such as 6 F2 or 4 F2 for each twin cell in an Open BL architecture, for example. By contrast, prior PUF DRAM designs due to the complexity of associated circuitry such as circuitry for discharge timing may be substantially larger. In some static random access memory (SRAM) PUF devices, the cell size may be quite large such as 9628 F, for example.

Still further write operations in physically unclonable function generation may be eliminated due to direct twin cell activation. Moreover, refresh operations to retain or maintain structure bit states in the physically unclonable function mode may be completely eliminated in some embodiments. Other aspects and advantages may be realized, depending upon the particular application.

### EXAMPLES

The following examples pertain to further embodiments.

Example 1 is an apparatus, comprising: a physically unclonable function device including: a memory having a plurality of bitcells, each bitcell comprising a pair of twin cells having a pair of bit line signal lines, and a controller including: structural bit state activation logic configured to activate complementary structural bit states of a pair of twin cells of a bitcell directly from no-write bit states of the pair of twin cells of the bitcell to output a physically unclonable memory bit of the bitcell as a function of the complementary structural bit states of the pair of twin cells of the bitcell, and read logic configured to read physically unclonable memory data including a plurality of physically unclonable memory bits from activated twin cells of the memory.

In Example 2, the subject matter of Examples 1-9 (excluding the present Example) can optionally include wherein the memory has a sense amplifier having inputs coupled to the signal lines of a pair of twin cells, the sense amplifier configured to read a physically unclonable memory bit from an activated pair of twin cells as a function of the structural bit states of the pair of the activated twin cells of the memory.

In Example 3, the subject matter of Examples 1-9 (excluding the present Example) can optionally include wherein each twin cell of each pair of twin cells has structural differences between each twin cell of the pair of twin cells and wherein the structural bit states of the pair of activated twin cells are a function of the structural differences between each twin cell of the pair of activated twin cells.

In Example 4, the subject matter of Examples 1-9 (excluding the present Example) can optionally include wherein the structural differences between each twin cell of the pair of activated twin cells include at least one of cell capacitance, parasitic capacitance, threshold voltage and resistance differences between each twin cell of the pair of twin cells.

In Example 5 the subject matter of Examples 1-9 (excluding the present Example) can optionally include wherein the structural differences between each twin cell of the pair of twin cells are a function of fabrication process variations in fabrication of each twin cell of the pair of twin cells.

In Example 6, the subject matter of Examples 1-9 (excluding the present Example) can optionally include cryptographic logic configured to generate a physically unclonable function in response to physically unclonable memory data read from the memory.

In Example 7, the subject matter of Examples 1-9 (excluding the present Example) can optionally include wherein the controller includes twin cell physically unclonable function mode logic which is configured to perform operations of a physically unclonable function mode, wherein the physically unclonable function mode logic is further configured to, in the physically unclonable function mode, power-up and maintain power to the memory in the absence of write operations so that the pair of twin cells of the bitcell have the no-write bit states before being activated to the complementary structural bit states by the structural bit state activation logic.

In Example 8, the subject matter of Examples 1-9 (excluding the present Example) can optionally include wherein the physically unclonable function mode logic includes the structural bit state activation logic which is configured to in the physically unclonable function mode, activate the complementary structural bit states of the pair of twin cells of the bitcell directly from the no-write bit states of the pair of twin cells of the bitcell in the absence of write operations in the physically unclonable function mode.

In Example 9, the subject matter of Examples 1-9 (excluding the present Example) can optionally include a system, said system comprising a central processing unit, said physically unclonable function device and at least one of:

a display communicatively coupled to the central processing unit, a network interface communicatively coupled to the central processing unit, and a battery coupled to provide power to the system.

Example 10 is a method, comprising:

activating complementary structural bit states of a pair of twin cells of a bitcell of a memory having a plurality of bit cells, the complementary structural bit states activated directly from no-write bit states of the pair of twin cells of the bitcell to output a physically unclonable memory bit of the bitcell as a function of the complementary structural bit states of the pair of twin cells of the bitcell, and

reading physically unclonable memory data including a plurality of physically unclonable memory bits from activated twin cells of the memory.

In Example 11, the subject matter of Examples 10-17 (excluding the present Example) can optionally include wherein reading a physically unclonable memory bit from activated twin cells of the memory includes sensing the structural bit states of the pair of the activated twin cells of the memory.

In Example 12, the subject matter of Examples 10-17 (excluding the present Example) can optionally include wherein the structural bit states of the pair of activated twin cells are a function of structural differences between each twin cell of the pair of activated twin cells.

In Example 13, the subject matter of Examples 10-17 (excluding the present Example) can optionally include wherein the structural differences between each twin cell of the pair of activated twin cells include at least one of cell capacitance, parasitic capacitance, threshold voltage and resistance differences between each twin cell of the pair of twin cells.

In Example 14, the subject matter of Examples 10-17 (excluding the present Example) can optionally include wherein the structural differences between each twin cell of the pair of twin cells are a function of fabrication process variations in fabrication of each twin cell of the pair of twin cells.

In Example 15, the subject matter of Examples 10-17 (excluding the present Example) can optionally include generating a physically unclonable cryptographic function in response to physically unclonable memory data read from the memory.

In Example 16, the subject matter of Examples 10-17 (excluding the present Example) can optionally include performing operations of a physically unclonable function mode, including powering-up and maintaining power to the memory in the absence of write operations so that the pair of twin cells of the bitcell have the no-write bit states before being activated to the complementary structural bit states.

In Example 17, the subject matter of Examples 10-17 (excluding the present Example) can optionally include wherein the physically unclonable function mode further includes activating the complementary structural bit states of the pair of twin cells of the bitcell directly from the no-write bit states of the pair of twin cells of the bitcell in the absence of write operations in the physically unclonable function mode.

Example 18 is an apparatus comprising means to perform a method as claimed in any preceding claim.

Example 19 is a system comprising:

a central processing unit, and

a physically unclonable function device including:

a memory having a plurality of bitcells, each bitcell comprising a pair of twin cells having a pair of bit line signal lines, and

a controller including:

structural bit state activation logic configured to activate complementary structural bit states of a pair of twin cells of a bitcell directly from no-write bit states of the pair of twin cells of the bitcell to output a physically unclonable memory bit of the bitcell as a function of the complementary structural bit states of the pair of twin cells of the bitcell, and

read logic configured to read physically unclonable memory data including a plurality of physically unclonable memory bits from activated twin cells of the memory.

In Example 20, the subject matter of Examples 19-27 (excluding the present Example) can optionally include wherein the memory has a sense amplifier having inputs coupled to the signal lines of a pair of twin cells, the sense amplifier configured to read a physically unclonable memory bit from an activated pair of twin cells as a function of the structural bit states of the pair of the activated twin cells of the memory.

In Example 21, the subject matter of Examples 19-27 (excluding the present Example) can optionally include wherein each twin cell of each pair of twin cells has structural differences between each twin cell of the pair of twin cells and wherein the structural bit states of the pair of activated twin cells are a function of the structural differences between each twin cell of the pair of activated twin cells.

In Example 22, the subject matter of Examples 19-27 (excluding the present Example) can optionally include wherein the structural differences between each twin cell of the pair of activated twin cells include at least one of cell capacitance, parasitic capacitance, threshold voltage and resistance differences between each twin cell of the pair of twin cells.

In Example 23, the subject matter of Examples 19-27 (excluding the present Example) can optionally include wherein the structural differences between each twin cell of the pair of twin cells are a function of fabrication process variations in fabrication of each twin cell of the pair of twin cells.

In Example 24, the subject matter of Examples 19-27 (excluding the present Example) can optionally include cryptographic logic configured to generate a physically unclonable function in response to physically unclonable memory data read from the memory.

In Example 25, the subject matter of Examples 19-27 (excluding the present Example) can optionally include wherein the controller includes twin cell physically unclonable function mode logic which is configured to perform operations of a physically unclonable function mode, wherein the physically unclonable function mode logic is further configured to, in the physically unclonable function mode, power-up and maintain power to the memory in the absence of write operations so that the pair of twin cells of the bitcell have the no-write bit states before being activated to the complementary structural bit states by the structural bit state activation logic.

In Example 26, the subject matter of Examples 19-27 (excluding the present Example) can optionally include wherein the physically unclonable function mode logic includes the structural bit state activation logic which is configured to in the physically unclonable function mode, activate the complementary structural bit states of the pair of twin cells of the bitcell directly from the no-write bit states of the pair of twin cells of the bitcell in the absence of write operations in the physically unclonable function mode, and

wherein the controller further includes mode selection logic configured to select various memory modes including a read/write memory mode and said physically unclonable function mode.

In Example 27, the subject matter of Examples 19-27 (excluding the present Example) can optionally include at least one of:

a display communicatively coupled to the central processing unit, a network interface communicatively coupled to the central processing unit, and a battery coupled to provide power to the system.

Example 28 is an apparatus, comprising: a physically unclonable function device including: a memory having a plurality of bitcells, each bitcell comprising a pair of twin cells having a pair of bit line signal lines, and a controller including: structural bit state activation logic means for activating complementary structural bit states of a pair of twin cells of a bitcell directly from no-write bit states of the pair of twin cells of the bitcell to output a physically unclonable memory bit of the bitcell as a function of the complementary structural bit states of the pair of twin cells of the bitcell, and read logic means for reading physically unclonable memory data including a plurality of physically unclonable memory bits from activated twin cells of the memory.

In Example 29, the subject matter of Examples 28-36 (excluding the present Example) can optionally include wherein the memory has a sense amplifier means having inputs coupled to the signal lines of a pair of twin cells, the sense amplifier means for sensing a physically unclonable memory bit from an activated pair of twin cells as a function of the structural bit states of the pair of the activated twin cells of the memory.

In Example 30, the subject matter of Examples 28-36 (excluding the present Example) can optionally include wherein each twin cell of each pair of twin cells has structural differences between each twin cell of the pair of twin cells and wherein the structural bit states of the pair of activated twin cells are a function of the structural differences between each twin cell of the pair of activated twin cells.

In Example 31, the subject matter of Examples 28-36 (excluding the present Example) can optionally include wherein the structural differences between each twin cell of the pair of activated twin cells include at least one of cell capacitance, parasitic capacitance, threshold voltage and resistance differences between each twin cell of the pair of twin cells.

In Example 32 the subject matter of Examples 28-36 (excluding the present Example) can optionally include wherein the structural differences between each twin cell of the pair of twin cells are a function of fabrication process variations in fabrication of each twin cell of the pair of twin cells.

In Example 33, the subject matter of Examples 28-36 (excluding the present Example) can optionally include cryptographic logic means for generating a physically unclonable function in response to physically unclonable memory data read from the memory.

In Example 34, the subject matter of Examples 28-36 (excluding the present Example) can optionally include wherein the controller includes twin cell physically unclonable function mode logic means for performing operations of a physically unclonable function mode, wherein the physically unclonable function mode logic means is further configured for, in the physically unclonable function mode, powering-up and maintaining power to the memory in the absence of write operations so that the pair of twin cells of the bitcell have the no-write bit states before being activated to the complementary structural bit states by the structural bit state activation logic means.

In Example 35, the subject matter of Examples 28-36 (excluding the present Example) can optionally include wherein the physically unclonable function mode logic means includes the structural bit state activation logic means which is further configured for in the physically unclonable function mode, activating the complementary structural bit states of the pair of twin cells of the bitcell directly from the no-write bit states of the pair of twin cells of the bitcell in the absence of write operations in the physically unclonable function mode.

In Example 36, the subject matter of Examples 28-36 (excluding the present Example) can optionally include a system, said system comprising a central processing unit, said physically unclonable function device and at least one of:

a display communicatively coupled to the central processing unit, a network interface communicatively coupled to the central processing unit, and a battery coupled to provide power to the system.

Example 37 is a computer program product for a computing system wherein the computer program product comprises a computer readable storage medium having program instructions embodied therewith, the program instructions executable by a processor of the computing system to cause operations, the operations comprising:

activating complementary structural bit states of a pair of twin cells of a bitcell directly from no-write bit states of the pair of twin cells of the bitcell to output a physically unclonable memory bit of the bitcell as a function of the complementary structural bit states of the pair of twin cells of the bitcell, and

reading physically unclonable memory data including a plurality of physically unclonable memory bits from activated twin cells of the memory.

In Example 38, the subject matter of Examples 37-44 (excluding the present Example) can optionally include wherein reading a physically unclonable memory bit from activated twin cells of the memory includes sensing the structural bit states of the pair of the activated twin cells of the memory.

In Example 39, the subject matter of Examples 37-44 (excluding the present Example) can optionally include wherein the structural bit states of the pair of activated twin cells are a function of structural differences between each twin cell of the pair of activated twin cells.

In Example 40, the subject matter of Examples 37-44 (excluding the present Example) can optionally include wherein the structural differences between each twin cell of the pair of activated twin cells include at least one of cell capacitance, parasitic capacitance, threshold voltage and resistance differences between each twin cell of the pair of twin cells.

In Example 41, the subject matter of Examples 37-44 (excluding the present Example) can optionally include wherein the structural differences between each twin cell of the pair of twin cells are a function of fabrication process variations in fabrication of each twin cell of the pair of twin cells.

In Example 42 the subject matter of Examples 37-44 (excluding the present Example) can optionally include wherein the operations further comprise generating a physically unclonable cryptographic function in response to physically unclonable memory data read from the memory.

In Example 43, the subject matter of Examples 37-44 (excluding the present Example) can optionally include performing operations of a physically unclonable function mode, including powering-up and maintaining power to the memory in the absence of write operations so that the pair of twin cells of the bitcell have the no-write bit states before being activated to the complementary structural bit states.

In Example 44, the subject matter of Examples 37-44 (excluding the present Example) can optionally include wherein the physically unclonable function mode further includes activating the complementary structural bit states of the pair of twin cells of the bitcell directly from the no-write bit states of the pair of twin cells of the bitcell in the absence of write operations in the physically unclonable function mode.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. An apparatus, comprising:
a physically unclonable function device including:
a memory having a plurality of bitcells, each bitcell comprising a pair of twin cells having a pair of bit line signal lines; and
a controller including:
structural bit state activation logic configured to activate complementary structural bit states of a pair of twin cells of a bitcell directly from no-write bit states of the pair of twin cells of the bitcell to output a physically unclonable memory bit of the bitcell as a function of the complementary structural bit states of the pair of twin cells of the bitcell; and
read logic configured to read physically unclonable memory data including a plurality of physically unclonable memory bits from activated twin cells of the memory.

2. The apparatus of claim 1 wherein the memory has a sense amplifier having inputs coupled to the signal lines of a pair of twin cells, the sense amplifier configured to read a physically unclonable memory bit from an activated pair of twin cells as a function of the structural bit states of the pair of the activated twin cells of the memory.

3. The apparatus of claim 2 wherein each twin cell of each pair of twin cells has structural differences between each twin cell of the pair of twin cells and wherein the structural bit states of the pair of activated twin cells are a function of the structural differences between each twin cell of the pair of activated twin cells.

4. The apparatus of claim 3 wherein the structural differences between each twin cell of the pair of activated twin cells include at least one of cell capacitance, parasitic capacitance, threshold voltage and resistance differences between each twin cell of the pair of twin cells.

5. The apparatus of claim 4 wherein the structural differences between each twin cell of the pair of twin cells are a function of fabrication process variations in fabrication of each twin cell of the pair of twin cells.

6. The apparatus of claim 1 further comprising cryptographic logic configured to generate a physically unclonable function in response to physically unclonable memory data read from the memory.

7. The apparatus of claim 1 wherein the controller includes twin cell physically unclonable function mode logic which is configured to perform operations of a physically unclonable function mode, wherein the physically unclonable function mode logic is further configured to, in the physically unclonable function mode, power-up and maintain power to the memory in the absence of write operations so that the pair of twin cells of the bitcell have the no-write bit states before being activated to the complementary structural bit states by the structural bit state activation logic.

8. The apparatus of claim 7 wherein the physically unclonable function mode logic includes the structural bit state activation logic which is configured to in the physically unclonable function mode, activate the complementary structural bit states of the pair of twin cells of the bitcell directly from the no-write bit states of the pair of twin cells of the bitcell in the absence of write operations in the physically unclonable function mode.

9. A method, comprising:
activating complementary structural bit states of a pair of twin cells of a bitcell of a memory having a plurality of bit cells, the complementary structural bit states activated directly from no-write bit states of the pair of twin cells of the bitcell to output a physically unclonable memory bit of the bitcell as a function of the complementary structural bit states of the pair of twin cells of the bitcell; and
reading physically unclonable memory data including a plurality of physically unclonable memory bits from activated twin cells of the memory.

10. The method of claim 9 wherein reading a physically unclonable memory bit from activated twin cells of the memory includes sensing the structural bit states of the pair of the activated twin cells of the memory.

11. The method of claim 10 wherein the structural bit states of the pair of activated twin cells are a function of structural differences between each twin cell of the pair of activated twin cells.

12. The method of claim 11 wherein the structural differences between each twin cell of the pair of activated twin cells include at least one of cell capacitance, parasitic capacitance, threshold voltage and resistance differences between each twin cell of the pair of twin cells.

13. The method of claim 9 wherein the structural differences between each twin cell of the pair of twin cells are a function of fabrication process variations in fabrication of each twin cell of the pair of twin cells.

14. The method of claim 12 further comprising generating a physically unclonable cryptographic function in response to physically unclonable memory data read from the memory.

15. The method of claim 9 further comprising performing operations of a physically unclonable function mode, including powering-up and maintaining power to the memory in the absence of write operations so that the pair of twin cells of the bitcell have the no-write bit states before being activated to the complementary structural bit states.

16. The method of claim 15 wherein the physically unclonable function mode further includes activating the complementary structural bit states of the pair of twin cells of the bitcell directly from the no-write bit states of the pair of twin cells of the bitcell in the absence of write operations in the physically unclonable function mode.

17. A system comprising:
a central processing unit; and
a physically unclonable function device including:
a memory having a plurality of bitcells, each bitcell comprising a pair of twin cells having a pair of bit line signal lines; and
a controller including:
structural bit state activation logic configured to activate complementary structural bit states of a pair of twin cells of a bitcell directly from no-write bit states of the pair of twin cells of the bitcell to output a physically unclonable memory bit of the bitcell as a function of the complementary structural bit states of the pair of twin cells of the bitcell; and
read logic configured to read physically unclonable memory data including a plurality of physically unclonable memory bits from activated twin cells of the memory.

18. The system of claim 17 wherein the memory has a sense amplifier having inputs coupled to the signal lines of a pair of twin cells, the sense amplifier configured to read a physically unclonable memory bit from an activated pair of twin cells as a function of the structural bit states of the pair of the activated twin cells of the memory.

19. The system of claim 18 wherein each twin cell of each pair of twin cells has structural differences between each twin cell of the pair of twin cells and wherein the structural bit states of the pair of activated twin cells are a function of the structural differences between each twin cell of the pair of activated twin cells.

20. The system of claim 19 wherein the structural differences between each twin cell of the pair of activated twin cells include at least one of cell capacitance, parasitic capacitance, threshold voltage and resistance differences between each twin cell of the pair of twin cells.

21. The system of claim 20 wherein the structural differences between each twin cell of the pair of twin cells are a function of fabrication process variations in fabrication of each twin cell of the pair of twin cells.

22. The system of claim 17 further comprising cryptographic logic configured to generate a physically unclonable function in response to physically unclonable memory data read from the memory.

23. The system of claim 17 wherein the controller includes twin cell physically unclonable function mode logic which is configured to perform operations of a physically unclonable function mode, wherein the physically unclonable function mode logic is further configured to, in the physically unclonable function mode, power-up and maintain power to the memory in the absence of write operations so that the pair of twin cells of the bitcell have the no-write bit states before being activated to the complementary structural bit states by the structural bit state activation logic.

24. The system of claim 23 wherein the physically unclonable function mode logic includes the structural bit state activation logic which is configured to in the physically unclonable function mode, activate the complementary structural bit states of the pair of twin cells of the bitcell directly from the no-write bit states of the pair of twin cells of the bitcell in the absence of write operations in the physically unclonable function mode; and
wherein the controller further includes mode selection logic configured to select various memory modes including a read/write memory mode and said physically unclonable function mode.

25. The system of claim 17 further comprising at least one of:
a display communicatively coupled to the central processing unit, a network interface communicatively coupled to the central processing unit, and a battery coupled to provide power to the system.
